(19) United States
(12) Patent Application Publication
(10) Pub. No.: US 2010/0089070 A1
(43) Pub. Date: Apr. 15, 2010

(54) Fluid Reservoir with Thermal Management

(76) Inventors: Thorsten Allgeier, Untergruppenbach (DE); Stephan Leuthner, Leonberg (DE); Jan-Mitchael Graehn, Stuttgart (DE); Werner Gruenwald, Gerlingen (DE); Ian Faye, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/513,768

(22) PCT Filed: Sep. 17, 2007
(86) PCT No.: PCT/EP2007/059771

§ 371 Date: Dec. 16, 2009

(30) Foreign Application Priority Data
Nov. 6, 2006 (DE) 10 2006 052 109.9

(51) Int. Cl. F17C 13/00; F25B 49/00

(52) U.S. Cl. 62/45.1; 62/132

(57) ABSTRACT

The invention relates to a fluid reservoir, particularly a fluid reservoir with a sorption medium. According to the invention an improvement is provided by a device for the temperature control of the fluid reservoir.

The present invention relates to a fluid reservoir, in particular a fluid reservoir with a sorption medium as generically defined by the preamble to claim 1.

### PRIOR ART

For storing fluids, especially gaseous fuels for operating motor vehicles, the use of sorption reservoirs, for instance based on metal hydrides, zeolites, or metal organic frameworks (MOFs), is known. When the tank is being filled, the so-called binding energy is released as heat and has to be removed. As a result of the attendant heating up of the tank, its storage capacity decreases and can accordingly no longer be fully utilized.

On the other hand, upon withdrawal of the gas from the tank, cooling of the reservoir because of the desorption process is found, which in turn adversely affects a withdrawal of the gas from the reservoir. The reason for this is a requisite minimum temperature for an unimpeded desorption process, which if the temperature drops below that is impeded markedly because it becomes difficult or impossible to release the gas, thus at least being a threat to an adequate supply of gas to the consumer from this gas tank, if not making it impossible.

### OBJECT AND ADVANTAGES OF THE PRESENT INVENTION

It is therefore the object of the present invention to improve a fluid reservoir of the type discussed at the outset.

This object is attained by the characteristics of claim 1. Advantageous and expedient refinements are disclosed in the dependent claims.

Accordingly, the present invention relates to a fluid reservoir with a sorption medium. This fluid reservoir is distinguished in that a device for tempering the fluid reservoir is provided. This device can preferably include a control unit for the temperature and/or the pressure in the fluid reservoir, which unit, in combination with correspondingly suitable means, is intended for both monitoring and varying the temperature or the pressure prevailing in the tank. Especially preferably, a closed-loop control circuit, which monitors the parameters to be varied, may be provided for the purpose.

By means of suitable regulation of the temperature or pressure prevailing in the tank, a marked increase in the energy density on refueling is possible, because of the thus-attainable greater storage density and thus a longer-lasting supply, referred to the quantity of gas consumed, to a consumer connected to the reservoir.

Besides increasing the fill factor of such a fluid reservoir, the improved reservoir emptying associated with the temperature control according to the invention has a favorable effect on the supply to the gas consumer of the resultant additionally usable quantity of gas. This is because by targeted raising of the temperature during the desorption process, comparatively more extensive evacuation of the tank is made possible.

In an especially preferred embodiment, the control unit may further include a module for controlling the temperature and/or pressure in the fluid reservoir in a way that anticipates demand. For instance, a tank interrogation process may be started in response to a relatively low reservoir filling, and this process in the event of positive signaling causes precooling of the tank to increase its storage capacity. Such a cooling process can also be done in a graduated way, for instance. To that end, in a first step, for instance, an approach to a minimum temperature that is still just barely sufficient for the current operating state of the consumer connected to the tank can be set for the sake of unimpeded gas withdrawal. This temperature prevailing in the tank can then be further reduced upon starting of the refueling process, so that the heat input occurring in refueling can be counteracted as effectively as possible.

One possible provision for temperature reduction would for instance be to lower the temperature by suitable means such as a heat exchanger or the like. However, it is also conceivable for the pressure prevailing in the tank to be reduced, so that the gas located in it can cool accordingly by expansion. In order for various operating states of the tank or of the consumer connected to it to be able to furnish optimal control, the control unit can furthermore include a values memory, in which certain temperature values of the fluid reservoir are associated with certain pressure values of the fluid reservoir, or vice versa.

It is thus possible at any time to subject the tank to an optimally adapted pressure for the particular process—gas withdrawal or gas delivery—to suit the temperature prevailing in the tank. Upon gas withdrawal, that is, on supply to the consumer, imposing a higher pressure with an associated increase in the temperature in the tank may be desirable. For influencing the reservoir in this way, it is furthermore advantageous if the control unit includes a values memory, in which certain pressure values and/or certain temperature values of the fluid reservoir are associated with certain fill factors of the fluid reservoir, or vice versa. As a result, an optimal adaptation of the closed-loop control circuit for regulating the temperature or pressure in the fluid reservoir to suit the current filling state is possible. As a result, an optimal temperature-pressure ratio for the desorption of the gas from the sorption medium can be attained, or on the other hand for the preparation for a sorption process when refueling is imminent.

Another possibility for favorably affecting the storage capacity of the tank is cooling the gas down before it flows into the tank. For that purpose, a coupling to a heat absorbing and/or emitting device can preferably be provided. Such a heat absorbing and/or emitting device may for instance be a heat exchanger that is disposed in a gas supply line to the tank.

However, in the tank as well, a disposition of such a heat exchanger is highly advantageous in view of effectively influencing the temperature prevailing in the interior of the tank. By the combination of two such heat exchangers, still further optimization is possible in terms of thermal management for such a fluid reservoir.

To enable appropriate and effective withdrawal of the heat thus drawn from the tank or the gas supply line and to store it temporarily, in a preferred embodiment a connection to a heating and/or cooling loop may be provided, and the heating and/or cooling loop can then serve as an intermediate buffer, for instance, for that energy. Once the refueling operation is concluded, this energy can then be resupplied to the sorption reservoir for re-release of the gas stored in the sorption medium, so that the temperature prevailing in the sorption reservoir can be raised at least far enough that sufficient desorption of the gas from the storage material for the current operating state of the consumer connected to it can be assured. A further possibility of varying the temperature in the interior of the tank is available by extraction or resupply of released or again-needed energy by means of this heating loop.

The heating and/or cooling loop may for instance be that of a thermal and/or mechanical energy converter, for instance in the form of a gas engine, turbine, heating system, or the like. The fluid reservoir can be used in both mobile and stationary fashion. A mobile application would for instance be the implementation of the reservoir in a vehicle. A stationary application could for instance be the supply to an autonomic system which has the aforementioned devices.

Further optimization of this thermal management of a fluid reservoir is possible for instance by means of a heat-transferring connection of the heating and/or cooling loop with an exhaust line of such a thermal and/or mechanical energy converter. As a result, the waste heat produced in combustion of the gas can likewise be used for heating the fluid reservoir, which is constantly cooled by the desorption process because of the extraction of gas from the sorption medium. Especially in cold weather, an additional heat input of this kind can have an especially advantageous effect on friction-free gas withdrawal from the sorption reservoir.

In another preferred embodiment, a tempering device, such as an air conditioning system in a motor vehicle or stationary autonomic system, as described above, may be associated with the heating and/or cooling loop. In stationary applications, such a tempering device may, however, also be nearly a heater, for instance whenever no cooling device is provided.

In order to assure an adequate gas supply, particularly upon starting of the consumer that is to be supplied by the reservoir, a heater can also be provided, which is operated for instance electrically and disposed in and/or on the tank, preferably distributed over the surface or distributed throughout the volume, in order to effect the fastest and most uniform possible heating of the tank, or at least part of it.

To further increase the operating safety, the disposition of a safety valve, for instance in the form of a drain valve, is proposed. As a result, pressure increases in the tank, which can occur for instance in the inactive state of an operating system that includes the fluid reservoir of the invention and caused for instance by sunshine, can also be limited.

A further safety feature can be implemented for instance by the provision of a barrier valve for the tank or for its supply line. This barrier valve may for instance also be actuated upon overheating of the tank, if a certain pressure value is exceeded, and/or in some other operating state that may possibly not be as intended, via a suitable circuit for interrupting the line between the tank and a refueling device.

### DESCRIPTION OF THE DRAWINGS

The present invention is described in further detail below in conjunction with the drawings and the description referring to them.

Shown are:

FIG. 1: as an example, a schematic circuit diagram for thermal management of a fluid reservoir, with a device for influencing the temperature or pressure prevailing in the reservoir on the basis of suitable sensors and actuators;

FIGS. 2 and 3: each, a modified embodiment compared to FIG. 1;

FIGS. 4 through 7: a qualitative course of variables associated with the sorption reservoir, such as the reservoir filling, pressure, temperature, and switching strategy, plotted over a common time axis;

FIGS. 8 through 13: as examples, further schematic circuit arrangements for a fluid reservoir, in part with different components; and

FIG. 14: as an example and schematically, a special embodiment of a fluid reservoir.

In detail, as an example and schematically, FIG. 1 shows a device 56 for tempering a fluid reservoir 1 to achieve thermal management for improving the storage capacity of such a fluid reservoir, taking safety aspects into account.

This device 56 includes a control unit 2 with a closed-loop control circuit 5 for influencing the temperature and/or the pressure in the interior of the fluid reservoir 1. For detecting the temperature and the pressure, suitable sensors 3, 4 are disposed on the fluid reservoir and connected to the control unit 2.

To enable control of the temperature and/or the pressure in the fluid reservoir 1 in anticipation of demand, the device 56 or the control unit 2 further includes a suitably designed module 6. As a result, the closed-loop control circuit 5, for instance, can be influenced in a such a way that before a starting operation of a consumer supplied by the fluid reservoir, the temperature in the fluid reservoir is raised far enough that a minimum quantity of gas for the particular operating state of the consumer at that time can be reliably withdrawn.

In view of a possibly imminent refueling operation, if the reservoir content is perhaps low, the regulator 5 can be varied by comparison such that the temperature in the fluid reservoir is lowered to as low a value as possible, to make it possible for the heat input to be expected as a result of the imminent refueling operation to be counteracted in advance.

Furthermore, the control unit 2 includes a values memory 7, in which certain temperature values of the fluid reservoir are associated with certain pressure values of the fluid reservoir, or vice versa.

In a further values memory 8, certain pressure values and/or certain temperature values of the fluid reservoir can be associated with certain fill factors of the fluid reservoir and vice versa. By access to these two values memories, the control unit, for instance taking into account the current operating state of the consumer supplied by the fluid reservoir, can regulate the temperature and/or pressure in the interior of the fluid reservoir in an optimally adapted way. In other words, during the normal withdrawal mode, a comparatively high temperature can be specified, to reinforce the desorption process from the sorption reservoir, or for a refueling operation, the imposition of as low as possible a temperature can be specified to increase the sorption capacity of the sorption reservoir, or the fill factor can be determined from the pressure and temperature.

For absorbing the binding energy, in the form of heat, that is liberated in refueling, a heat absorbing and/or emitting device 9 is provided, embodied here as a heat exchanger, for example. This heat exchanger may be disposed both in the fluid reservoir and around it. It is especially advantageous if this heat exchanger is distributed uniformly in the interior of the fluid reservoir, for instance by means of suitably laid pipelines or the like, so that a predominantly uniform heat absorption and redispensing of heat are possible. To enable carrying the heat received via the heat exchanger out of the fluid reservoir, a coolant pump 10 is furthermore provided, which communicates, carrying coolant, with the heat exchanger 9 via suitable coolant lines 11.

Via the connection 12, the heat exchanger 9 communicates with a heating and/or cooling loop 13, which in this special embodiment here is for example associated with an air conditioning system 14.

For further influence on the coolant flow in the coolant line 11, a valve 15 is also shown as an example here, which may be embodied as both a regulating valve and a shutoff valve.

For supplying gas from the fluid reservoir, once again as an example in schematic, a connection 16 is shown, which may be embodied for instance in the form of a tank connection for connection to a tank line in a service station. Originating from this connection, a tank supply line 17 to the fluid tank 1 is shown, in which optionally a barrier valve 19 may be provided in order to interrupt the tank fuel in the event of problems that might occur.

The gas flowing into the tank from the tank supply line 17, in the embodiment shown here, also flows through the heat exchanger 9, so that before it enters the tank 1, it can be cooled down in its temperature by heat extraction, to increase the storage capacity of the tank.

It should be noted here that this embodiment of the heat exchanger 9 need not be in contrast to the heat exchanger 9 described above; instead, it may selectively be an independent version, or optionally a combination with this heat exchanger described first.

The gas stream flowing through the fluid reservoir, first for the sake of absorption by sorption in the sorption medium and later for desorption with regard to dispensing through the tank outlet line 18, is represented as an example and symbolically as an arrow 21.

Also as an example, a safety valve 20 is shown in the region of the tank outflow line 18. By means of this valve, if impermissible operating conditions perhaps occur, such as excessive heating from sunshine or the like, a pressure relief of the tank can be brought about.

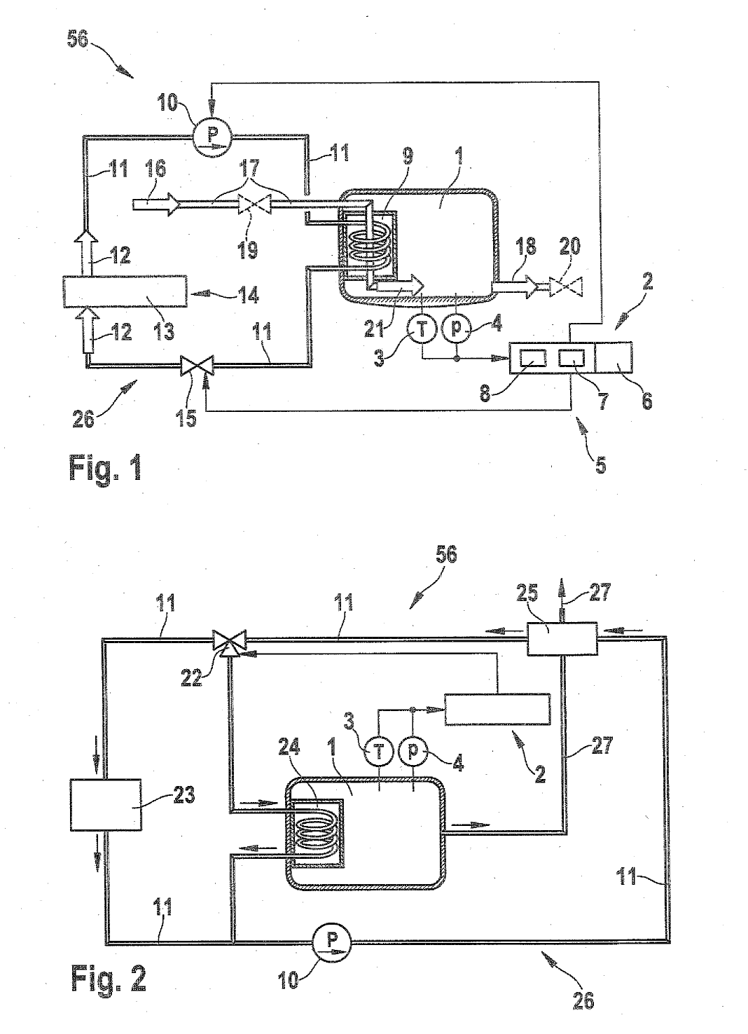

In FIG. 2, a modified embodiment compared to FIG. 1 of an exemplary and symbolic interconnection of a corresponding fluid reservoir is shown. The heat exchanger 24 shown here communicates via an adjusting and/or shutoff valve 22 and coolant lines 11 with the radiator 23 of a mechanical and/or thermal energy converter on the one hand, and on the other with the heating or cooling line that extends through the energy converter 25.

By means of this connection to the heat absorbing and/or emitting device, in this case in the form of the heating and/or cooling loop of the energy converter 25, the heat released upon refueling of the fluid reservoir can be temporarily stored in this heating and/or cooling loop and recovered again as needed. The energy converter 25 may for instance be a motor or a fuel cell or optionally a heating system.

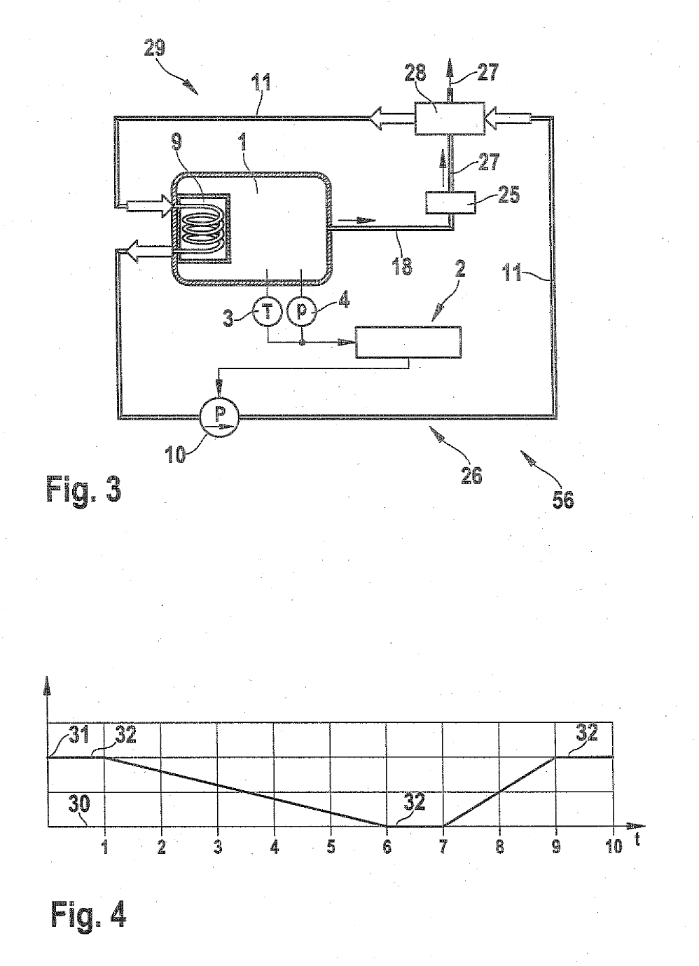

In FIG. 3, a further possibility of recovery of the heat released in the energy conversion by the energy converter 25 is shown in such a form that the heat (enthalpy) output via the exhaust gas by the energy converter 25 [verb missing] by means of a heat exchanger 28 incorporated into the exhaust lines 27. At this point, it should be mentioned once again that among other reasons for the sake of simplicity, not all the components that may be necessary for operating the fluid reservoir are always shown in all the drawings. Similarly, not every detail for every drawing is discussed individually; instead, see the pertinent or merely analogous descriptions of the other drawings above.

Individual components of the heating and/or cooling loop 26 are associated with a tempering device 14 in the manner for instance already essentially discussed in the description of FIG. 1, in which the tempering device is for instance in the form of an air conditioning system 14 shown there. This air conditioning system 14 can also serve the purpose of temporary storage or buffering of the heat released in refueling of the fluid reservoir.

Such coupling with an air conditioning system is especially advantageous because an air conditioning system has an additional, comparatively high heat storage capacity, which is already present in a suitably equipped system, such as a motor vehicle, and thus can be effectively utilized without major additional expense.

An embodiment in which a heater 29 is provided is for instance likewise shown symbolically and as an example in FIG. 3. The heater 29 includes the coupling of the heating and/or cooling loop 26 to the exhaust gas heat of the energy converter 25 and its transfer via the coolant lines 11 for heating the fluid reservoir 1 by means of the heat exchanger 9. However, still other embodiments of heaters are conceivable, such as a heater, embedded in the fluid reservoir and/or encasing it, that can be heated, for instance by means of a suitably tempered fluid, but heating it directly by electrical energy is entirely conceivable as well.

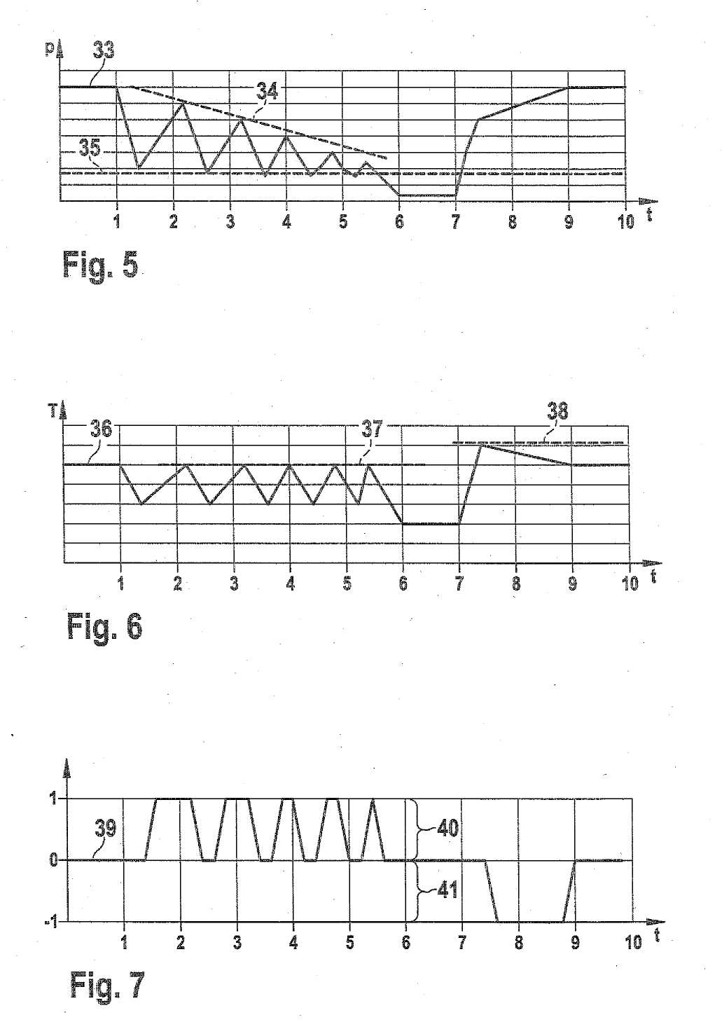

FIGS. 4 through 7 show the qualitative course of various variables with respect to the identical course over time for a certain period of operation of the fluid reservoir. FIG. 4 shows the course over time of the reservoir filling; FIG. 5, for the same period of time, shows the course of the pressure in the interior of the reservoir; FIG. 6 accordingly shows the course of the temperature; and FIG. 7 shows the circuitry course of thermal management of the control unit belonging to the fluid reservoir for varying the temperature and/or pressure in the fluid reservoir 1.

Accordingly, at the onset of the plotting, in position 31, the reservoir is full, and over the time in operation, it empties in the direction of the level 30, which symbolically represents an empty reservoir and which is reached for instance after six units of time. Between the time units 6 and 7, the tank status is shown as empty, and beginning at time unit 7, because of a refueling process, it rises until time unit 9, after which it remains in the filled state as indicated by the fill value line 32.

FIG. 5 shows the associated pressure value line 33 for the pressure prevailing in the interior of the fluid reservoir, with an upper threshold value 34 as a function of the filling and a lower threshold value of the pressure 35.

FIG. 6 shows a correspondingly associated temperature value line 36, with an upper temperature threshold value 37 and a maximum threshold value 38 of the temperature on refueling. FIG. 7 in turn, in correspondingly the same chronological association, shows a line 39 of the tempering course. The area 40 lying above the value of zero symbolically represents the state of heating that is activated multiple times during the withdrawal of gas from the fluid tank, in order to reinforce the desorption process for release of the gas bound in the sorption reservoir. The area 41 lying below the value of zero, in the opposite direction, indicates cooling of the tank to reinforce the takeup of gas in the fluid reservoir or for increasing the maximum usable storage volume of this fluid reservoir.

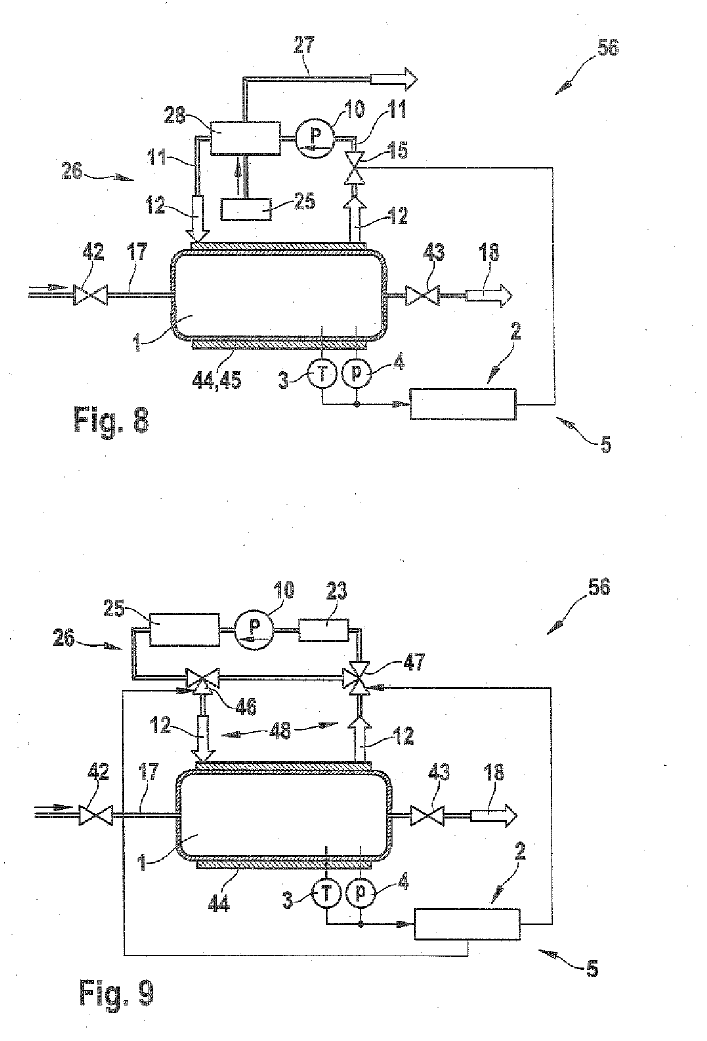

FIGS. 8 through 13 as examples show further schematic embodiments for thermal management of a fluid reservoir. In FIG. 8, accordingly, a refueling valve 42 and a withdrawal valve 43 are additionally shown. With suitable interconnection, these valves may for instance also take on the respective functions of the two valves 19 and 20 shown in FIG. 1. A heat exchanger 44 is shown here as an example as a means for varying the temperature of the fluid reservoir from outside. This embodiment may be implemented for instance by means of a casing of the fluid reservoir 1. For instance, for that purpose, lines wound spirally or in a coil around the fluid reservoirs 1 could cover the fluid reservoir, in order to extract heat from it or to resupply heat to it as needed. The connection is once again symbolically represented as in the view in FIG. 1 with reference numeral 12. The heating and/or cooling loop 26 in this embodiment as well includes a heat exchanger 28 that converts the waste heat of an engine 25.

FIG. 9 again shows a further-modified embodiment, in which two bypass valves 46, 47 enable the disconnection of the heating and/or cooling loop of the engine 25 from the heating and/or cooling loop 48 of the heat exchanger 44.

FIG. 10, in a further possible, symbolically shown embodiment, shows a heat exchanger 49, which is disposed in the interior of the gas reservoir 1, which in this case is shown for instance with lines connected in the manner of radiators, with two connections 12 for varying the heat in the interior of the fluid reservoir. The coupling of this heat exchanger 49, in this exemplary embodiment, is provided to an air conditioning system 14, particularly for the sake of temporary storage of the heat to be carried away or fed back in again.

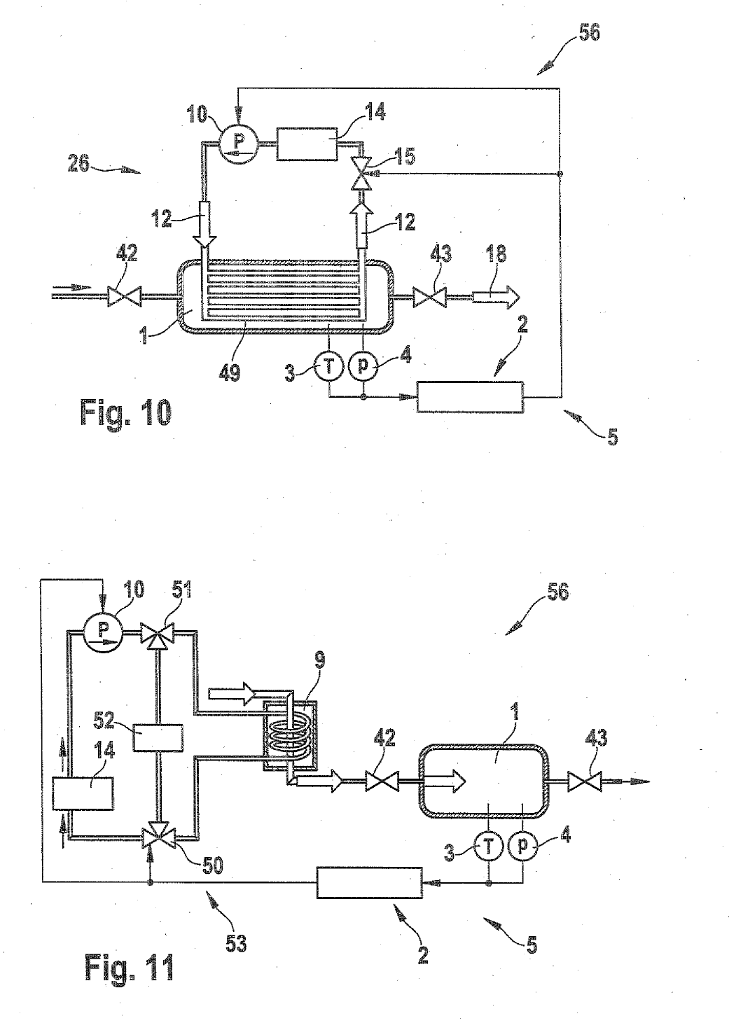

FIG. 11 as an example shows an embodiment in which once again the coupling of a heat exchanger 9 to a vehicle air conditioning system 14 is provided. Here, the heat exchanger 9 serves to cool down the gas, supplied to the fluid reservoir 1, before it enters the reservoir in the refueling operation. A heating and/or cooling device 52 for a passenger compartment is interposed in a bypass circuit 53 of the coolant and/or heating medium loop, via two bypass valves 50, 51. This circuit is especially well suited to climatic conditions in which the heat produced on refueling can increase the overall efficiency of the system supplied by the gas reservoir 1 for heating the passenger compartment.

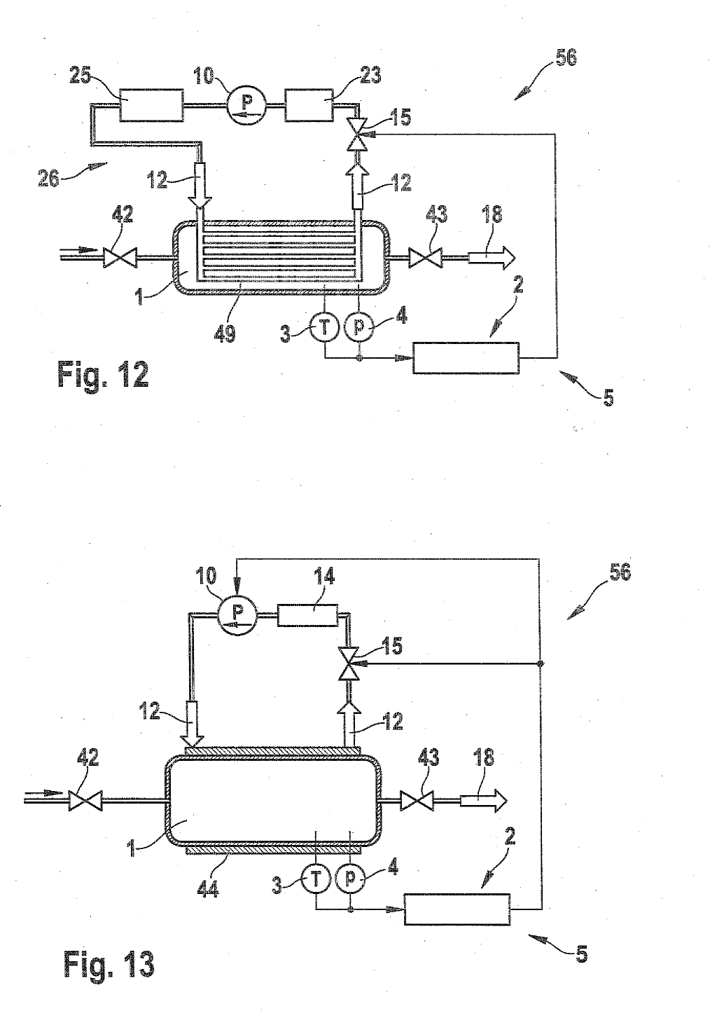

FIG. 12 shows a modified embodiment, compared to FIG. 10, such that the coupling of the heat exchanger 49, disposed in the interior of the gas reservoir 1, to an energy converter 25 and its radiator 23 is proposed.

FIG. 13, conversely, shows an embodiment with a heat exchanger 44 sheathing the fluid reservoir 1 on the outside, corresponding to the embodiment in FIG. 9, that in turn is coupled in a heat-transferring way to an air conditioning system 14.

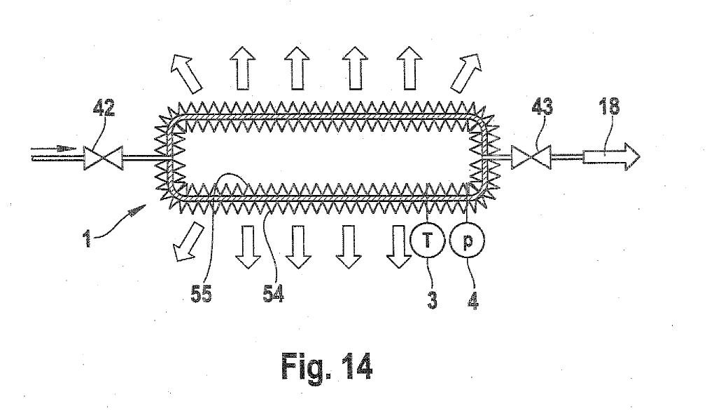

FIG. 14, in a further detailed view, shows a further embodiment of a fluid reservoir 1 with a heat exchanger or cooling fins 54 on the outside and cooling fins 55 on the inside, which for instance may also be part of the above-described embodiments of a heat exchanger. However, it is also possible for at least some regions of the cooling fins to be embodied as merely passive cooling fins, for instance in the form of a casing extending around the outside of the fluid reservoir 1. Regardless of this, however, a further portion of these cooling fins may certainly be part of the above-described heat exchanger, for instance the cooling fins 55 disposed in the interior of the gas reservoir.

From the great number of embodiments shown, it can be seen that the variations shown here are not a conclusive or limiting example, but instead merely represent examples of various possible embodiments for various intended applications.

1-14. (canceled)

15. A fluid reservoir with a sorption medium, including a device for tempering the fluid reservoir.

16. The fluid reservoir as defined by claim 15, wherein the device includes a control unit.

17. The fluid reservoir as defined by claim 15, wherein the control unit includes a closed-loop control circuit.

18. The fluid reservoir as defined by claim 16, wherein the control unit includes a closed-loop control circuit.

19. The fluid reservoir as defined by claim 15, wherein the control unit includes a module for controlling temperature and/or pressure in the fluid reservoir in anticipation of demand.

20. The fluid reservoir as defined by claim 17, wherein the control unit includes a module for controlling temperature and/or pressure in the fluid reservoir in anticipation of demand.

21. The fluid reservoir as defined by claim 15, wherein the control unit includes a values memory, in which certain temperature values of the fluid reservoir are associated with certain pressure values of the fluid reservoir, or vice versa.

22. The fluid reservoir as defined by claim 20, wherein the control unit includes a values memory, in which certain temperature values of the fluid reservoir are associated with certain pressure values of the fluid reservoir, or vice versa.

23. The fluid reservoir as defined by claim 15, wherein the control unit includes a values memory, in which certain pressure values and/or certain temperature values of the fluid reservoir are associated with certain fill factors of the fluid reservoir, or vice versa.

24. The fluid reservoir as defined by claim 22, wherein the control unit includes a values memory, in which certain pressure values and/or certain temperature values of the fluid reservoir are associated with certain fill factors of the fluid reservoir, or vice versa.

25. The fluid reservoir as defined by claim 15, wherein a heat absorbing and/or emitting device is provided.

26. The fluid reservoir as defined by claim 24, wherein a heat absorbing and/or emitting device is provided.

27. The fluid reservoir as defined by claim 25, wherein the heat absorbing and/or emitting device includes a connection to a heating and/or cooling loop.

28. The fluid reservoir as defined by claim 26, wherein the heat absorbing and/or emitting device includes a connection to a heating and/or cooling loop.

29. The fluid reservoir as defined by claim 25, wherein the heating and/or cooling loop is associated with a thermal and/or mechanical energy converter.

30. The fluid reservoir as defined by claim 25, wherein the heating and/or cooling loop communicates in a heat-transferring manner with an exhaust line of a thermal and/or mechanical energy converter.

31. The fluid reservoir as defined by claim 25, wherein a tempering device is associated with the heating and/or cooling loop.

32. The fluid reservoir as defined by claim 15, wherein a heater is provided.

33. The fluid reservoir as defined by claim 15, wherein a safety valve is provided.

34. The fluid reservoir as defined by claim 15, wherein a barrier valve is provided.
